(19) United States
(12) Patent Application Publication
(10) Pub. No.: US 2011/0239553 A1
(43) Pub. Date: Oct. 6, 2011

(54) System and method for installation of wire including use of flexible metal conduit

(76) Inventor: Sidney Wierstra, Grand Valley (CA)

(21) Appl. No.: 12/924,042

(22) Filed: Sep. 16, 2010

(30) Foreign Application Priority Data
Sep. 17, 2009 (CA) CA 2 679 913

(51) Int. Cl. E04C 2/52; H02G 1/08

(52) U.S. Cl. 52/173.1; 254/134.3 R

(57) ABSTRACT

A method is provided for installing wire at an installation including delineating a wire run for installing at least one wire within the installation and identifying at least one first portion of the wire run requiring a metal protection for the wire and at least one second portion of the wire run not-requiring a metal protection for the wire, where the first portion includes at least one non-linear segment. For the first portion, at least one continuously welded corrugated flexible metal tube is installed for the first portion, where at the non-linear segment the corrugated flexible metal tubing is manually bent to fit a path of the wire run. A wire is installed through the first and second portions of the wire run, where during the portions of the wire run in the at least one first portion, the wire is passed through the corrugated flexible metal tubing.

### RELATED APPLICATION

This application claims the benefit of priority from Canadian Patent Application No. CA 2 678 913, filed on Sep. 17, 2009, the entirety of which is incorporated by reference.

### BACKGROUND

1. Field of the Invention

The present application relates to electrical tubing. More particularly, the present application relates to flexible metal electrical tubing.

2. Description of Related Art

In the area of building/plant/business/installation wiring, there are numerous safety standards that must be adhered to. One such regulation is that wiring that would otherwise be exposed (outside of a wall) is typically required to be held within some form of protection.

One common form of protection is Electrical Metal Tubing (EMT) and elbows (in trade sizes ⅜-4 inches) which are used as metal raceways for the installation of wires and cables and made in the USA to UL 797 standard and installed in accordance with the National Electrical Code (NEC) and made in Canada to CSA C22.2 No. 83 and installed in accordance with the Canadian Electrical Code (CEC).

EMT is a rigid conduit and must be shaped, optionally threaded and mounted which can be very labor intensive, especially when a lot of shaping is required. Optionally, when EMT is not threaded, connectors and/or elbows are affixed to the EMT and screwed to hold them in place. Typically, threading of EMT is carried out for wet locations or if the application requires an intrinsically safe installation.

An alternative arrangement involves the use of an armored cable, which is useful when a lot of shaping is required. Armored cable uses an interlock armor, which is a helically applied aluminum, or other metal (e.g. steel), strip that is crimped or locked to the prior adjacent helical wrap, forming a continuous, flexible armor around the underlying wires. However, the interlock armor, although meeting physical barrier regulations, is not fluid proof and thus does not offer protection against smoke or water ingress. This protection may be achieved by the addition of a polymer jacket over the interlock armor. However, such a solution has significant added cost to the production and still provides lesser protection than typical EMT.

Thus, although flexible interlock armored cable has nearly eliminated the cost associated with shaping conduit, the cost of flexible interlock armored cable is more than double when compared to EMT. Moreover, cable with interlock armor is sold pre-armored. Thus, in situations where only a portion of the cabling run needs to be armored (e.g. the rest may be within a wall) the installer, if using interlock armored cable, needs to install the cable for the entire run, thus adding unnecessary costs.

Yet another alternative arrangement is to install Flex Tube™ which is essentially interlock armor, without the wires inside. However. installers do not prefer this alternative, because such tubing does not hold its shape when it is placed in the wall so it must be affixed in many locations in the wall partitions. Also, Flex Tube™ remains at a significantly higher cost than EMT, similar to the drawback with flexible interlock armored cable, and thus it is not used often as an electrical conduit option.

### OBJECTS AND SUMMARY

The present invention overcomes the drawbacks associated with the two common prior art methods and provides for a flexible conduit or Electrical Bendable Metal Tube (EBMT) made from a continuous welded sheath with corrugations added, which allow the user to shape the conduit by hand or a manual tool and fit it as needed. This tubing has an advantage over EMT in that it is hand bendable and will bend to a radius equal to that of interlock armored cable or Flex Tube™. However, unlike interlock armored cable, EBMT is produced as a solid conduit and is not manufactured over the wires so it may be installed only where necessary. Moreover, the EBMT of the present application is a solid product unlike Flex Tube™, which is a crimped helical wound tape. EBMT is made with continuous welding and thus may be employed to meet stricter protection standards, such as protection from smoke and water, without the need to add an additional polymer jacket.

For example, EBMT according to the present application may meet the standards of UL 1 and CSA C22.2 No. 56.04 for flexible metal tubing and UL 97A, and CSA C22.2 No. 83 performing similarly on the tests met by the non-flexible EMT.

### BRIEF DESCRIPTION OF THE DRAWINGS

The present invention can be best understood through the following description and accompanying drawings, wherein:

FIG. 1 shows a cross section view of EBMT according to one embodiment;

FIG. 2 shows a perspective view of the EBMT of FIG. 1 according to one embodiment;

FIG. 3 shows a series of bending steps A1-A6, showing the formation of EBMT of FIGS. 1 and 2; and

FIG. 4 shows an exemplary installation using the EBMT of FIGS. 1 and 2 according to one embodiment.

### DETAILED DESCRIPTION

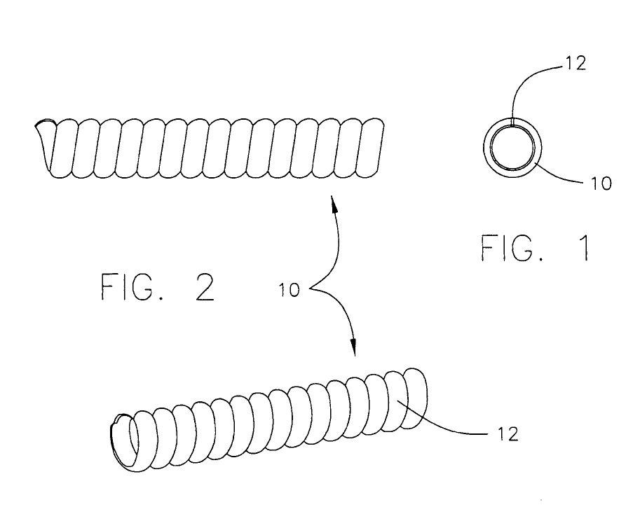

In one embodiment, the originating material, such as aluminum, steel or other suitable metal/alloy is cut into a continuous flat strip of a width that substantially corresponds to the intended diameter of the Electrical Bendable Metal Tube (EBMT) 10 as shown in FIG. 1. The size of EBMT 10 preferably ranges from ½″ diameter through 4″. For the purposes of illustrating the salient features of the invention, an exemplary ½″ diameter is used.

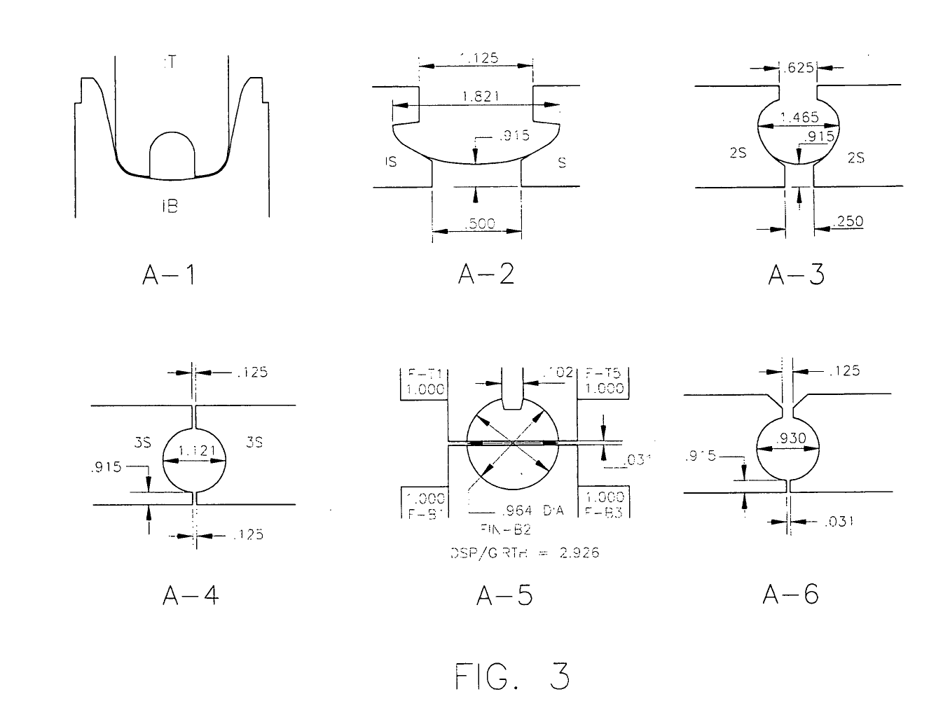

After the strip is cut, forming rollers bend the strip into a tube formation where an inline welding device welds the single seam continuously to form the solid tube 10. FIG. 3 shows an exemplary series of bending steps A1-A6 for a 0.920″ OD tube 10. After tube 10 is welded along seam 12 as shown in FIG. 1, a corrugation die places a helical corrugation formation on tube 10 as shown in FIG. 2. Other types of corrugations, such concentric rings, not helical rings, may be used as well and could be applied here.)

The result is that corrugated flexible metal tubing 10 is provided that may be used in place of EMT and which is easily bent by hand, by the installer. Additionally, the solid welded construction allows for a completed tube, with no air gaps contributing to the ability to meet the required safety standards met by typical EMT.

For example, an EBMT corrugated flexible tubing 10 at ½″ diameter meets the requirements for CSA C22.2 No 56-04 (Flexible metal conduit and liquid-tight flexible metal conduit) including:

Interior Surface—The interior surface of the conduit 10 is free from burrs and sharp edges that might cause abrasion of the coverings on the conductors.

Flexibility—Flexible metal conduit 10 can be bent without opening up at any point around a 6″ mandrel

Internal Diameter—Min. 0.625″—Actual 0.710″ for EBMT 10

External Diameter—Max 0.920″—Actual 0.890″ for EBMT 10

Finished Conduit Tension—Finished conduit 10 is capable of withstanding an axial tension of 300 lb_{f} for 60 seconds, without opening up of the conduit's convolutions.

These measurements correspond to the ½″ size standards for comparison purposes with Flex Tube™ standards.

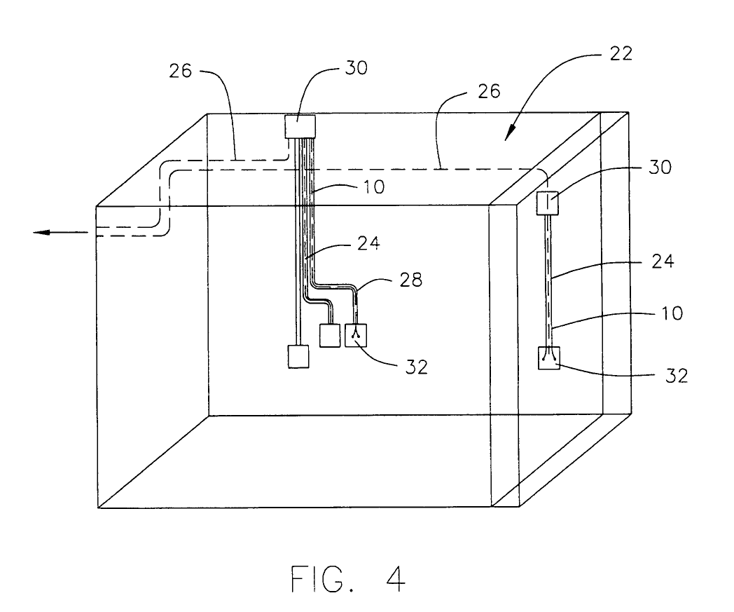

In one embodiment as shown in FIG. 4, an exemplary installation 20 is shown having a wire run 22 progressing there through. A first portion 24 of wire run 22 is exposed and therefore requires certain wiring standards that would apply to EMT. A second portion 26 of wire run 22 is within the walls/ceiling etc. and does not require EMT tubing.

An installer, after reviewing wire run 22, installs tubing 10 over the exposed first portion 24 of wire run 22. At the non-linear portions 28 of exposed first portion 24 of wire run 22 the wire, metal tubing 10 is simply hand-bent by the installer. Various coupling boxes 30 may be employed at the transition portions between first and second portions 24 and 26 of wire run 22.

After tubing 10 is installed, a wire 32 may be run along wire run 22 in installation 20, and, during the first portion 24 may be run through tubing 10. Such an arrangement allows the installer to use non-armored wire 32 for a majority of wire run 22 and only employ tubing 10 where needed, reducing the cost of safety compliance. Although this is similar to prior art EMT, the present tubing 10 has the advantage of being flexible (hand bendable) and thus does not require any of the complicated installation tooling required for EMT tubing.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A method for installing wire at an installation, said method including the steps of:
delineating a wire run for installing at least one wire within said installation;
identifying at least one first portion of said wire run requiring a metal protection for said at least one wire and at least one second portion of said wire run not-requiring a metal protection for said at least one wire, where said first portion of said wire run requiring a metal protection includes at least one non-linear segment;
for said at least one first portion of said wire run requiring a metal protection for said at least one wire, installing at least one continuously welded corrugated flexible metal tubing for said at least one first portion, wherein at said non-linear segment said corrugated flexible metal tubing is manually bent to fit a path of said wire run; and
installing at least one wire run through said at least said first and second portions of said wire run, wherein during said portions of said wire run in said at least one first portion, said wire is passed through said corrugated flexible metal tubing.

2. The method as claimed in claim 1, wherein said continuously welded corrugated flexible metal tube is formed from a metal strip bent into a substantially cylindrical conduit and welded along a single seam.

3. The method as claimed in claim 2, wherein said continuously welded corrugated flexible metal tube is formed by corrugating said substantially cylindrical conduit and welding along a single seam.

4. The method as claimed in claim 2, wherein said continuously welded corrugated flexible metal tube is formed with either one of helical or concentric corrugations.

5. The method as claimed in claim 1, wherein said continuously welded corrugated flexible metal tube meets the UL 1 and CSA C22.2 No. 56.04 standards for flexible metal tubing and UL 97A, as well as CSA C22.2 No. 83 standards for non-flexible EMT.

6. An installation, comprising:
at least one wire run for installing at least one wire within said installation;
said wire run having at least one first portion of said wire run requiring a metal protection for said at least one wire and at least one second portion of said wire run not-requiring a metal protection for said at least one wire, where said first portion of said wire run requiring a metal protection includes at least one non-linear segment;
for said at least one first portion of said wire run requiring a metal protection for said at least one wire, at least one continuously welded corrugated flexible metal tube for said at least one first portion, wherein at said non-linear segment said corrugated flexible metal tube is bent to fit a path of said wire run; and
at least one wire run through said at least said first and second portions of said wire run, wherein during said portions of said wire run in said at least one first portion, said wire is passed through said corrugated flexible metal tube.

7. The installation as claimed in claim 6, wherein said continuously welded corrugated flexible metal tube is formed from a metal strip bent into a substantially cylindrical conduit and welded along a single seam.

8. The installation as claimed in claim 7, wherein said continuously welded corrugated flexible metal tube is formed by corrugating said substantially cylindrical conduit and welding along a single seam.

9. The installation as claimed in claim 7, wherein said continuously welded corrugated flexible metal tube is formed with either one of helical or concentric corrugation.

10. The installation as claimed in claim 6, wherein said continuously welded corrugated flexible metal tube meets the UL 1 and CSA C22.2 No. 56.04 standards for flexible metal tubing and UL 97A, as well as CSA C22.2 No. 83 standards for non-flexible EMT.

11. An installation, comprising:
at least one wire run for installing at least one wire within said installation;
said wire run having at least one first portion of said wire run requiring a metal protection for said at least one wire and at least one second portion of said wire run not-requiring a metal protection for said at least one wire, wherein said first portion of said wire run requiring a metal protection includes any one of linear and non-linear segments;
for said at least one first portion of said wire run requiring a metal protection for said at least one wire, at least one continuously welded corrugated flexible metal tube for said at least one first portion, wherein at said both linear and non-linear segments said corrugated flexible metal tube is fitted to a path of said wire run; and
at least one wire run through said at least said first and second portions of said wire run, wherein during said portions of said wire run in said at least one first portion, said wire is passed through said corrugated flexible metal tube.
